(19) United States
(12) Patent Application Publication
(10) Pub. No.: US 2021/0322808 A1
(43) Pub. Date: Oct. 21, 2021

(54) EXPENDABLE AIR SEPARATION MODULE OPERATION FOR CARGO FIRE SUPPRESSION LOW RATE OF DISCHARGE

(71) Applicant: Hamilton Sundstrand Corporation, Charlotte, NC (US)

(72) Inventors: Jonathan Rheaume, West Hartford, CT (US); Haralambos Cordatos, Colchester, CT (US)

(21) Appl. No.: 17/233,851

(22) Filed: Apr. 19, 2021

Related U.S. Application Data
(60) Provisional application No. 63/012,472, filed on Apr. 20, 2020.

(51) Int. Cl. A62C 3/08; A62C 2/04

(52) U.S. Cl. CPC A62C 3/08; A62C 2/04

(57) ABSTRACT

Fire suppression system for an aircraft including a pressurized air source and an air separation module arranged between the pressurized air source and a fire-protected space. The air separation module configured to generate an inerting gas from pressurized air supplied from the pressurized air source and supply the inerting gas to the fire-protected space. The fire suppression system includes a first thermal conditioning system arranged upstream of the air separation module. The first thermal conditioning system configured to increase a temperature of the pressurized air prior to entry into the air separation module. The fire suppression system includes a valve arranged upstream of the fire-protected space and downstream of the air separation module.

### CROSS-REFERENCE TO RELATED APPLICATIONS

This application claims the benefit of U.S. Provisional Application No. 63/012,472 filed Apr. 20, 2020, the disclosure of which is incorporated herein by reference in its entirety.

### BACKGROUND

The subject matter disclosed herein generally relates to aircraft tools, and more specifically, to fire suppression systems for aircraft.

In general, cargo fire suppression systems utilize a halon based low rate discharge system. Halon is slowly being phased out of cargo fire suppression systems. Thus, new cargo fire suppression systems may be desirable.

### BRIEF SUMMARY

According to one embodiment, a fire suppression system for an aircraft is provided. The fire suppression system includes a pressurized air source and an air separation module arranged between the pressurized air source and a fire-protected space. The air separation module configured to generate an inerting gas from pressurized air supplied from the pressurized air source and supply the inerting gas to the fire-protected space. The fire suppression system includes a first thermal conditioning system arranged upstream of the air separation module. The first thermal conditioning system configured to increase a temperature of the pressurized air prior to entry into the air separation module. The fire suppression system includes a valve arranged upstream of the fire-protected space and downstream of the air separation module.

In addition to one or more of the features described above, or as an alternative, further embodiments may include a second thermal conditioning system arranged downstream of the air separation module and upstream of at least one of a fuel tank or the fire-protected space. The second thermal conditioning system configured to reduce a temperature of the inerting gas prior to entry into at least one of the fuel tank or the fire-protected space.

In addition to one or more of the features described above, or as an alternative, further embodiments may include that the valve is arranged upstream of the second thermal conditioning system.

In addition to one or more of the features described above, or as an alternative, further embodiments may include that the valve is arranged downstream of the second thermal conditioning system.

In addition to one or more of the features described above, or as an alternative, further embodiments may include an air separation module cooling heat exchanger located upstream of the air separation module. The pressurized air passes through the air separation module cooling heat exchanger upstream of the air separation module.

In addition to one or more of the features described above, or as an alternative, further embodiments may include that the first thermal conditioning system includes a bypass line and a bypass valve, wherein the bypass valve is operable to divert at least a portion of the pressurized air around the air separation module cooling heat exchanger.

In addition to one or more of the features described above, or as an alternative, further embodiments may include that the first thermal conditioning system includes a heater configured to increase a temperature of the pressurized air after passing through the air separation module cooling heat exchanger.

In addition to one or more of the features described above, or as an alternative, further embodiments may include that the heater is at least one of an electric heater, a combustion heater, a powered heater or a heat exchanger.

In addition to one or more of the features described above, or as an alternative, further embodiments may include that the first thermal conditioning system includes a boost compressor configured to increase a pressure of the pressurized air after passing through the air separation module cooling heat exchanger.

In addition to one or more of the features described above, or as an alternative, further embodiments may include a boost bypass valve controllable to enable bypassing of the boost compressor.

In addition to one or more of the features described above, or as an alternative, further embodiments may include that the air separation module cooling heat exchanger is located in a ram air duct.

In addition to one or more of the features described above, or as an alternative, further embodiments may include that the second thermal conditioning system includes a product gas cooler located in a ram air duct.

In addition to one or more of the features described above, or as an alternative, further embodiments may include that the product gas cooler is located upstream relative to the air separation module cooling heat exchanger within the ram air duct.

In addition to one or more of the features described above, or as an alternative, further embodiments may include a controller configured to control operation of at least one of the first thermal conditioning system or the valve.

In addition to one or more of the features described above, or as an alternative, further embodiments may include a vacuum generation system operably connected to the air separation module, the vacuum generation system being configured to increase a pressure differential across the air separation module.

In addition to one or more of the features described above, or as an alternative, further embodiments may include a first stage fire suppression system configured to release a selected amount of a fire suppression agent into the fire-protected space for a first period of time prior to or overlapping with the inerting gas entering into the fire-protected space.

According another embodiment, a method of supplying inerting gas to a fire-protected space of an aircraft for fire suppression is provided. The method includes: extracting pressurized air from a pressurized air source; increasing a temperature of the pressurized air with a first thermal conditioning system located upstream of an air separation module; passing the pressurized air from the thermal conditioning system into the air separation module to generate an inerting gas; and supplying the inerting gas to the fire-protected space of the aircraft for fire suppression.

In addition to one or more of the features described above, or as an alternative, further embodiments may include: actuating a three way valve to supply the inerting gas to fire-protected space.

In addition to one or more of the features described above, or as an alternative, further embodiments may include: detecting a fire in the fire-protected space using a fire detection sensor; and actuating a three way valve to supply the inerting gas to fire-protected space in response to detection of the fire.

In addition to one or more of the features described above, or as an alternative, further embodiments may include: supplying a selected amount of a fire suppression agent into the fire-protected space for a first period of time prior to or overleaping with the inerting gas entering into the fire-protected space.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

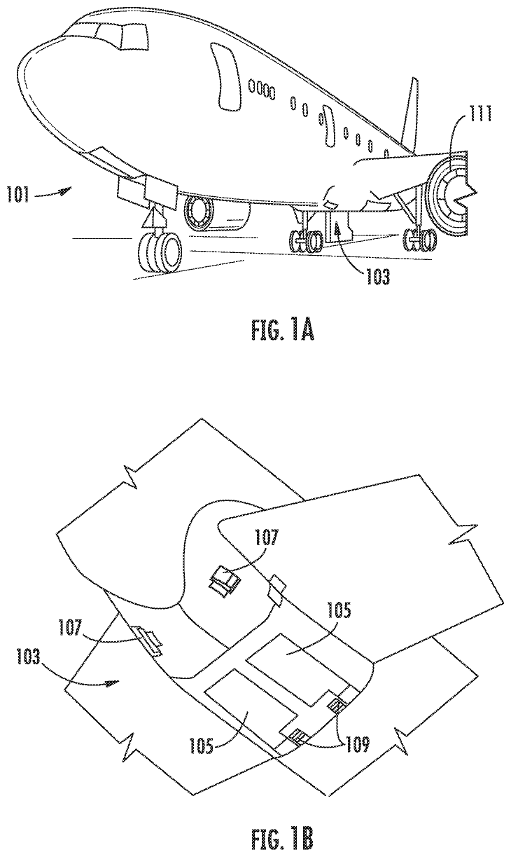

FIG. 1A is a schematic illustration of an aircraft that can incorporate various embodiments of the present disclosure;

FIG. 1B is a schematic illustration of a bay section of the aircraft of FIG. 1A;

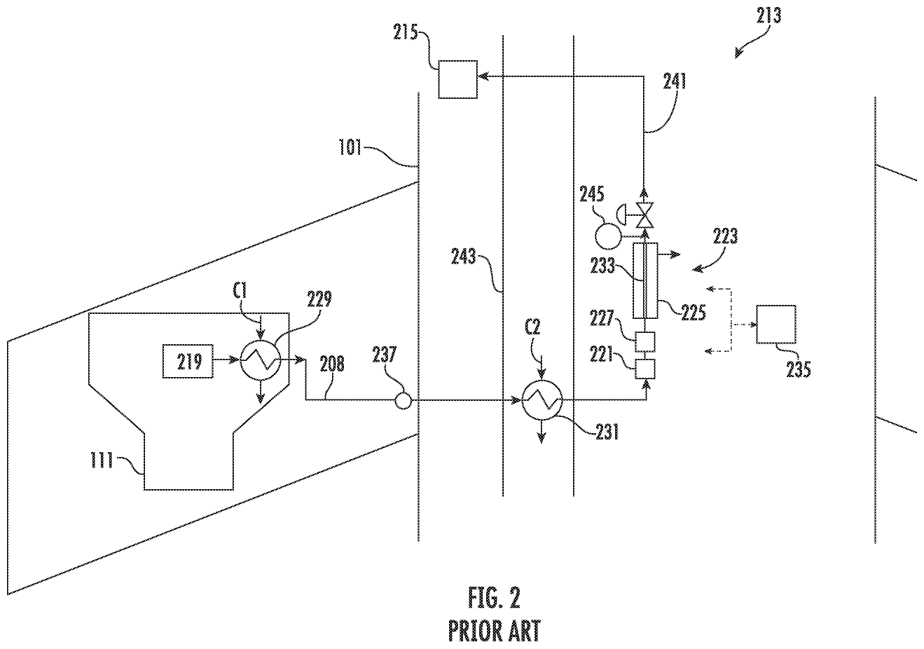

FIG. 2 is a schematic illustration of a prior system configuration of an inerting gas system;

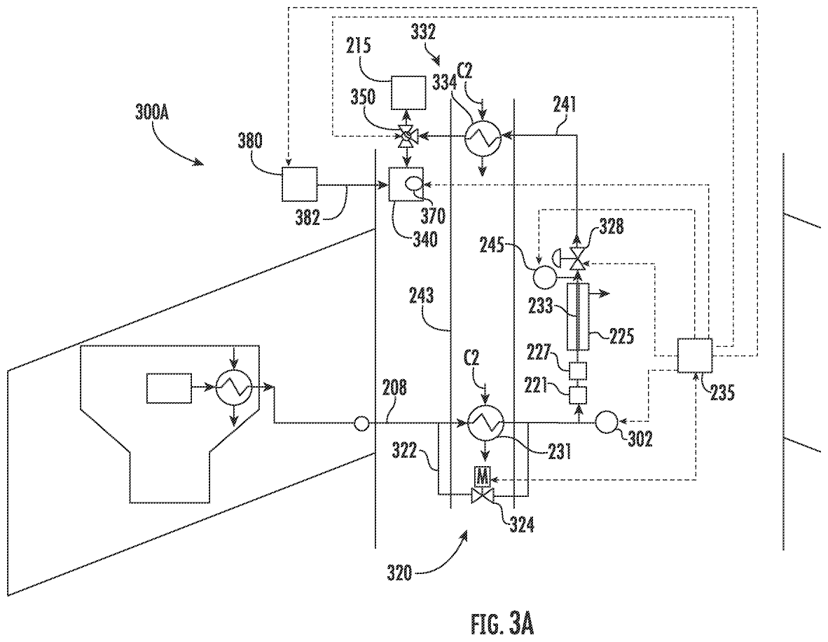

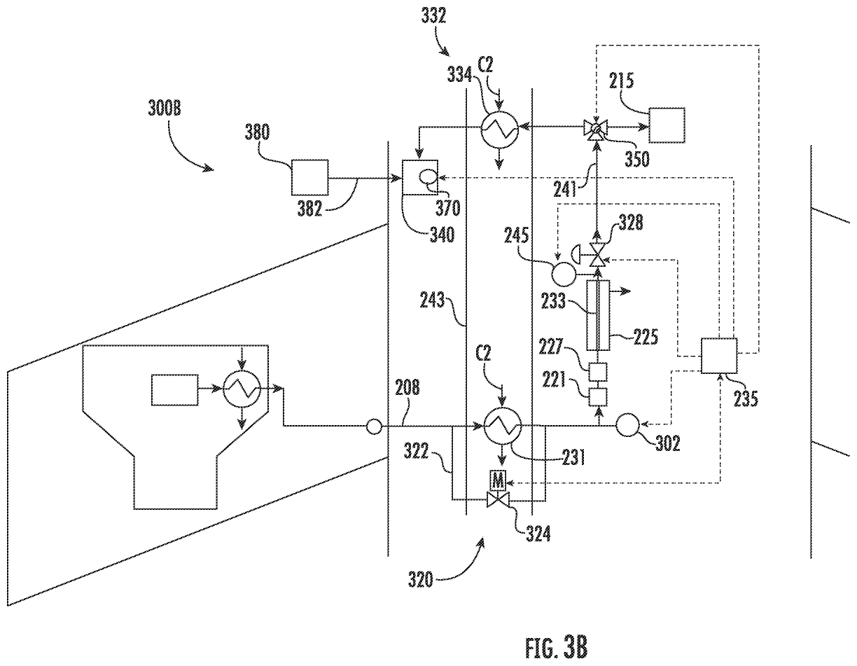

FIG. 3A is a schematic illustration of a fire suppression system in accordance with an embodiment of the present disclosure;

FIG. 3B is a schematic illustration of a fire suppression system in accordance with an embodiment of the present disclosure;

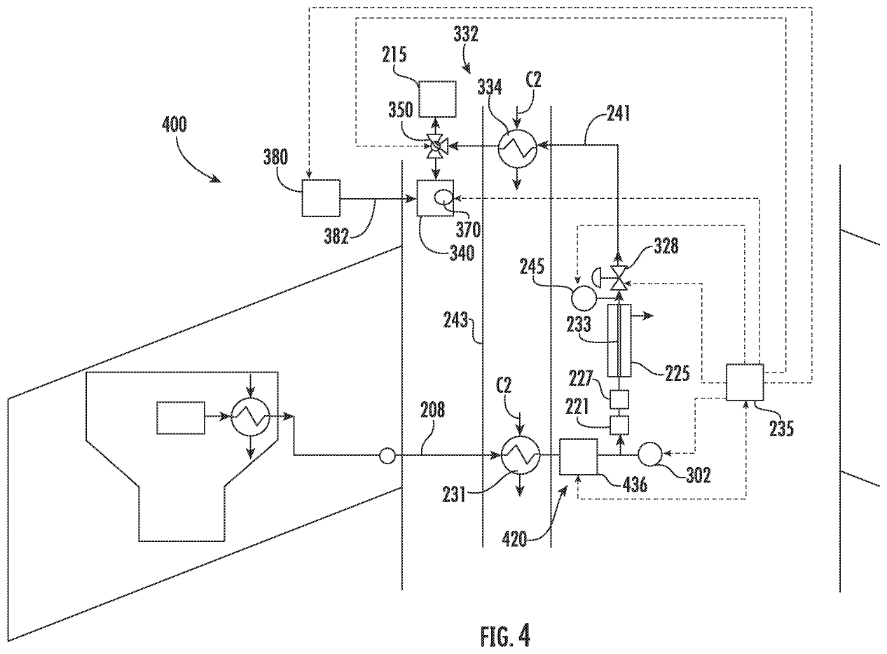

FIG. 4 is a schematic illustration of a fire suppression system in accordance with an embodiment of the present disclosure;

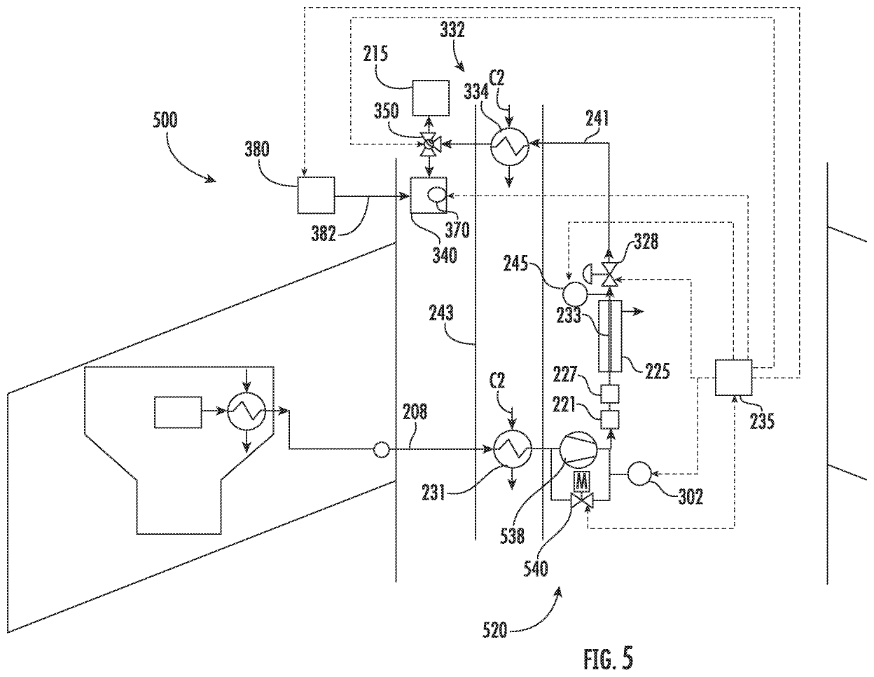

FIG. 5 is a schematic illustration of a fire suppression system in accordance with an embodiment of the present disclosure;

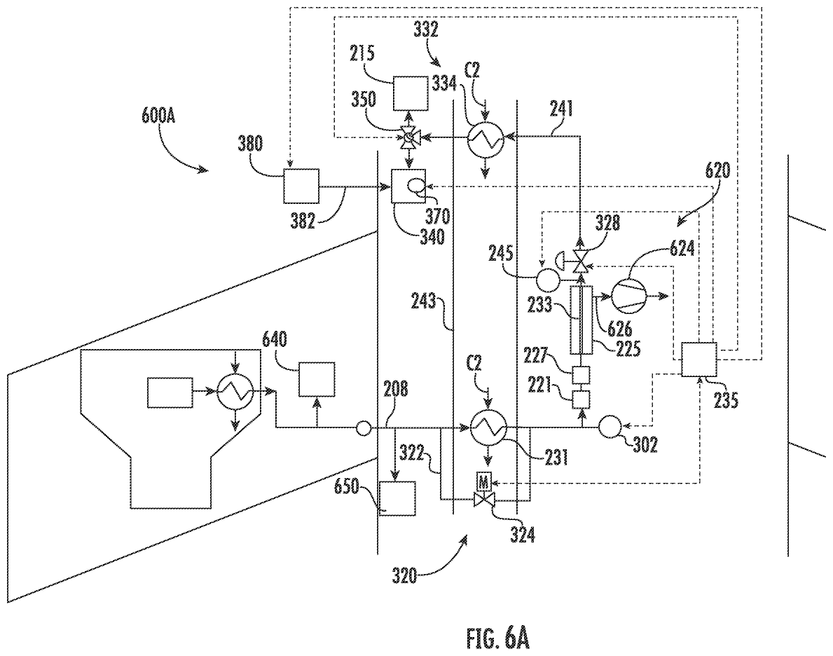

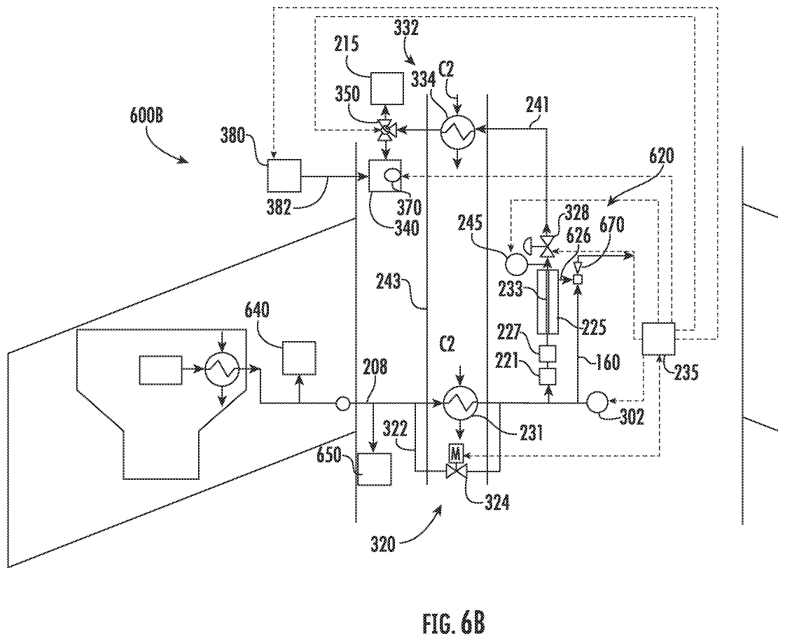

FIG. 6A is a schematic illustration of a fire suppression system in accordance with an embodiment of the present disclosure;

FIG. 6B is a schematic illustration of a fire suppression system in accordance with an embodiment of the present disclosure; and

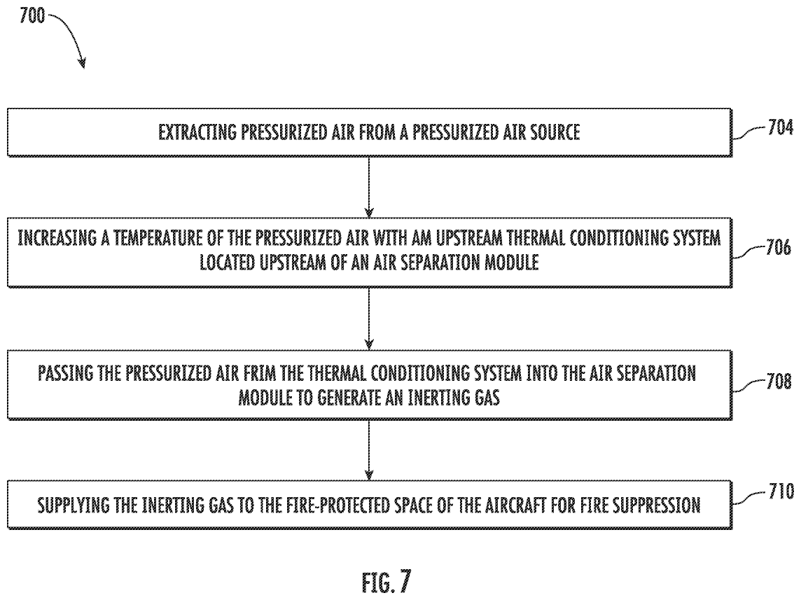

FIG. 7 is a flow process for using inerting gas for fire suppression in accordance with an embodiment of the present disclosure.

### DETAILED DESCRIPTION

A detailed description of one or more embodiments of the disclosed apparatus and method are presented herein by way of exemplification and not limitation with reference to the Figures.

FIGS. 1A-1B are schematic illustrations of an aircraft 101 that can employ one or more embodiments of the present disclosure. As shown in FIGS. 1A-1B, the aircraft 101 includes bays 103 beneath a center wing box. The bays 103 can contain and/or support one or more components of the aircraft 101. For example, in some configurations, the aircraft 101 can include environmental control systems and/or fuel tank inerting systems within the bays 103. As shown in FIG. 1B, the bays 103 includes bay doors 105 that enable installation and access to one or more components (e.g., environmental control systems, fuel tank inerting systems, etc.). During operation of environmental control systems and/or fuel tank inerting systems of the aircraft 101, air that is external to the aircraft 101 can flow into one or more environmental control systems within the bay doors 105 through one or more ram air inlets 107. The air may then flow through the environmental control systems to be processed and supplied to various components or locations within the aircraft 101 (e.g., flight deck, passenger cabin, etc.). Some air may be exhausted through one or more ram air exhaust outlets 109.

Also shown in FIG. 1A, the aircraft 101 includes one or more engines 111. The engines 111 are typically mounted on wings of the aircraft 101, but may be located at other locations depending on the specific aircraft configuration. In some aircraft configurations, air can be bled from the engines 111 and supplied to environmental control systems and/or fuel tank inerting systems, as will be appreciated by those of skill in the art.

Turning now to FIG. 2, a schematic illustration of an inerting system 213 for generating and supplying a source of inerting gas to another component, such as a fuel tank 215 on an aircraft 101, is illustrated. The inerting system 213 includes a supply of pressurized air 208 provided (i.e., extracted) from a pressurized air source 219 which is employed to generate an inerting gas 241. The inerting gas 241 may be fully inert or partially inert. In the illustrated non-limiting embodiment, the pressurized air source 219 includes one or more engines 111 of the aircraft 101, or a bleed port thereof, as will be appreciated by those of skill in the art. In such embodiments, the pressurized air 208 may be bled from a compressor section of the engine 111. In an embodiment, the pressurized air source 219 is at least a part of an engine 111 of the aircraft 101. However, embodiments where the pressurized air source 219 is not an engine are also contemplated herein. For example, in some non-limiting embodiments, the pressurized air source 219 includes a compressor configured to pressurize ambient air as it passes therethrough. The compressor may be driven by a mechanical, pneumatic, hydraulic, or electrical input, as will be appreciated by those of skill in the art.

Within the inerting system 213, the pressurized air 208 may flow through a filter 227 before being provided to an on-board inert gas generating system (OBIGGS) 223, including at least one air separation module (ASM) 225 for removing oxygen from the pressurized air 208 supplied from the pressurized air source 219. The filter 227 may comprise one or more filters, such as a coalescing filter to remove particulate contaminants and moisture, and a carbon filter for removing hydrocarbons from the pressurized air 208 supplied from the pressurized air source 219. Alternatively, or in addition, the pressurized air 208 may pass through an ozone conversion device 221 that is configured to reduce the ozone concentration of the pressurized air 208 before being provided to the OBIGGS 223. Although the filter 227 is illustrated as being downstream of the ozone conversion device 221 such configuration is not to be limiting. For example, in some embodiments, the filter 227 may be arranged downstream of the ozone conversion device 221. Further, it should be understood that both the filter 227 and ozone conversion device 221 may be arranged at any relative position within the inerting system 213, upstream from the OBIGGS 223.

The temperature of the pressurized air 208 should be below a maximum allowable temperature to maintain the safety of the downstream components, as well as the safety of the fuel tank 215. Because the pressurized air 208 from the pressurized air source 219 is generally extremely hot, the pressurized air 208 is typically cooled before being processed (e.g., within the filter 227, ozone conversion device 221, and/or OBIGGS 223). Accordingly, one or more cooling devices, such as heat exchangers, may be used to control the temperature of the pressurized air within the inerting system 213 before being provided to the OBIGGS 223. For example, the inerting system 213 includes a precooler 229 that arranges the pressurized air 208 in a heat transfer relationship with a secondary cooling flow C1, such as fan bypass air from the pressurized air source 219. Within the precooler 229, the pressurized air 208 may be reduced to a temperature less than or equal to about 200° C. The inerting system 213 may additionally include an ASM cooling heat exchanger 231 configured to further cool the pressurized air 208 prior to supplying the air to the OBIGGS 223. In some embodiments, a secondary cooling flow C2, such as ambient air supplied through a ram air duct 243, is arranged in a heat transfer relationship with the pressurized air 208 within the ASM cooling heat exchanger 231 and is configured to reduce the temperature of the pressurized air 208 to a desired temperature, for example, less than or equal to about 80° C. at sea level on a hot day.

In some embodiments, the ambient airflow used as the secondary cooling flow C2 can be directed within the aircraft body by a low-drag air inlet (e.g., National Advisory Committee for Aeronautics (NACA) duct or NACA scoop), etc. In some embodiments, the secondary cooling flow C2 may be conditioned air from an environmental control system of the aircraft 101. In some embodiments, the secondary cooling flow C2 can be cooled by an air cycle machine such as an environmental control system of the aircraft 101. In some embodiments, the secondary cooling flow C2 utilizes a vapor cycle machine for cooling. In some embodiments, the secondary cooling flow C2 can be a fuselage outflow to utilize airflow from within a passenger cabin, cargo hold, or flight deck of the aircraft. In some embodiments, the secondary cooling flow C2 can be fan bleed air from an engine of the aircraft. In some embodiments, the secondary cooling flow C2 can be a combination or hybrid of the airflow sources described herein. In some embodiments, airflow sources can be selectively provided and combined to provide a desired secondary cooling flow C2. Typical air separation modules, such as ASM 225, operate using pressure differentials to achieve a desired air separation. Such systems require a high pressure pneumatic source to drive the separation process across a membrane 233 of the ASM 225. In view of the above, a specific configuration is not contemplated as limiting, but rather various configurations and/or arrangements may be implemented without departing from the scope of the present disclosure.

The inerting system 213, as shown, includes a controller 235 that is operably coupled to one or more of the components of the inerting system 213. For example, the controller 235 may be configured to operate a flow control device 237 to control the flow rate of the pressurized air 208 through the inerting system 213. In addition, the controller 235 may be associated with an external source to initiate and terminate a secondary fluid within the ASM 225, as will be appreciated by those of skill in the art. Further, the controller 235 may be operably connected to one or more sensors 245, such as oxygen sensors for measuring the amount of oxygen in the pressurized air 208 and/or the inerting gas 241 that is provided to the fuel tank 215, or a sensor for monitoring one or more conditions associated with the fuel tank 215, such as a flow rate, quantity of fuel, and fuel demand. The controller 235 may be configured to receive an output from the sensors to adjust one or more operating conditions of the inerting system 213.

In some embodiments, a portion of the pressurized air 208 may be extracted and/or supplied to various other components or systems of the aircraft 101. For example, a portion of the pressurized air 208 may be supplied to an anti-ice system within or on the wings of the aircraft 101. Further, a portion (e.g., a majority in some systems) may be supplied to an environmental control system of the aircraft 101, as will be appreciated by those of skill in the art. The remainder may then flow through the inerting system 213, as described above, to generate the inerting gas 241.

As is known in the art, Halon may be utilized for cargo fire suppression systems. Cargo fire suppression may have multiple stages. In one example, the cargo fire suppression may have two stages. In a first stage, a large and quick inrush of Halon may be injected into the fire-protected space of an aircraft 101, which is then followed by a second stage of sustained low rate discharge of Halon (i.e., cargo fire suppression low rate of discharge). The fire-protected space may include but is not limited to a cargo area, an equipment bay, an electronics compartment, or any other space that may be outfitted with a fire protection system known to one of skill in the art. Halon is starting to be phased out of use in aircraft fire suppression systems due to its high ozone depletion potential and global warming potential.

Inerting gas may be utilized for fire suppression, but current ASMs that are sized for fuel tank inerting have insufficient flow for cargo fire suppression low rate of discharge (i.e., the second stage of cargo fire suppression). Embodiments, disclosed herein seek to improve the performance of inerting gas for both fuel tank inerting and cargo fire suppression low rate discharge by increasing the temperature and/or pressure.

The equation that describes the gas flux through a membrane of an ASM is:

J=K*A*dP (1)

In Equation (1), J is the flux or rate of inerting gas generation, K is permeance (permeation into and through the membrane which is a function of temperature), A is the area of the membrane, and dP is the differential pressure across the selective layer of the ASM. Embodiments described herein are directed to increasing permeance K (e.g., by increasing temperature) and to increasing pressure differential dP (e.g., higher pressure at inlet, lower pressure at outlet).

The temperature may be increased past normal operating levels of the membrane during a fire suppression event to increase generation of inerting gas to suppress a fire. After a fire suppression event, the membrane may need to be replaced. The high temperature exposure shortens the operating life of the membrane. For normal operation of a membrane, the temperature for fuel tank inerting is selected to be a relatively low temperature (e.g. 180° F.) as a tradeoff of performance for membrane longevity.

A fire suppression system of an aircraft is flight-critical on the aircraft and therefore the aircraft cannot be dispatched without a properly functioning fire suppression system. Membrane-based inerting gas generation for fuel tank inerting is not flight-critical and therefore the aircraft can fly for a certain duration without the fuel tank inerting system functioning. Embodiments herein seek to convert an air separation module to a dual duty fire suppression system and a fuel tank inerting system, which makes the air separation module flight-critical. Typically flight-critical components have back-up systems for redundancy. For example, commercial aircraft have two aircraft engines, never just one. Embodiments disclosed herein are also applicable to redundant air separation systems for at least one of a fuel tank inerting system or a fire suppression system.

Turning now to FIGS. 3A and 3B, a schematic illustration of a fire suppression system 300A, 300B is illustrated in accordance with an embodiment of the present disclosure. The fire suppression system 300A, 300B may be similar to that shown and described above with reference to FIG. 2, but provides for improved performance of the inerting gas through fuel tank inerting and cargo fire suppression by increased temperatures at the ASM 225. It is understood that while one ASM 225 is illustrated, the embodiments described herein may be applicable to fire suppression systems 300A, 300B comprising one or more ASMs 225. The fire suppression system 300A, 300B includes a valve 350 to supply inerting gas 241 to the fuel tank 215 and/or a fire-protected space 340. The fire-protected space 340 may include but is not limited to a cargo area, an equipment bay, an electronics compartment, or other any other space that may be outfitted with a fire protection system known to one of skill in the art. The valve 350 may be a multi-port valve, a combination of one or more valves, a three-way valve, or any other valve or valve system known to one of skill in the art. In one embodiment, the valve 350 is configured to simultaneously supply inerting gas 241 to both the fuel tank 215 and the fire-protected space 340 via a valve 350. In another embodiment, the valve 350 is configured to supply inerting gas 241 to the fuel tank 215 or the fire-protected space 340 at a single time. The location of the valve 350 along a flow path of inerting gas 241 may vary as shown in FIG. 3A in comparison to FIG. 3B. As illustrated in FIG. 3A, the valve 350 may be arranged downstream of a product gas cooler 334. As illustrated in FIG. 3B, the valve 350 may be arranged downstream of the ASM 225 and upstream of the product gas cooler 334.

The fire suppression system 300A, 300B includes an ASM 225 arranged along a flow path and configured to generate inerting gas 241 and supply such inerting gas to the fuel tank 215 and/or a fire-protected space 340 via the valve 350. The ASM 225 may be a membrane-based ASM, similar to that described above.

Pressurized air 208 (e.g., bleed air) is passed through upstream components, such as a precooler, and subsequently passed through an ASM cooling heat exchanger 231 that is configured to further cool the pressurized air 208 prior to supplying the air to the ASM 225. The ASM cooling heat exchanger 231 may be arranged within a ram air duct 243, similar to the arrangement described above. Further, the fire suppression system 300A, 300B, as shown, includes an ozone conversion device 221 and a filter 227, arranged upstream of the ASM 225. The fire suppression system 300A, 300B further includes a controller 235 that is operably coupled to one or more of the components of the fire suppression system 300A, 300B.

In the fire suppression system 300A, 300B a mechanism for increasing the temperature at the inlet to the ASM 225, or upstream thereof, is provided. In this non-limiting embodiment, a first thermal conditioning system 320 is provided. In this embodiment, the first thermal conditioning system 320 is configured to enable a portion (or all) of the relatively warm/hot air to bypass the ASM cooling heat exchanger 231, thus preventing cooling of the pressurized air 208 within the ASM cooling heat exchanger 231. Further, if a portion of the pressurized air 208 is caused to bypass the ASM cooling heat exchanger 231, the bypassing portion may be mixed with pressurized air that has been passed through the ASM cooling heat exchanger 231, thus enabling a mixture of air temperatures, to achieve a desired air temperature upstream of the ASM 225.

Accordingly, in this embodiment, the first thermal conditioning system 320 includes a bypass line 322 and a bypass valve 324. The bypass valve 324 is operable to divert at least a portion of the pressurized air 208 around the ASM cooling heat exchanger 231. The bypass valve 324, in some embodiments, may be operably connected to and/or controlled by the controller 235. The bypass valve 324 may be an actuated bypass valve. The bypass line 312 and the bypass valve 324 may be sized such that when bypass valve 324 is actuated to an open position, a pressure drop in the pressurized air 208 flowing through the bypass line 312 and the bypass valve 324 is substantially less than a pressure drop in the pressurized air 208 flowing through the ASM cooling heat exchanger 231. Advantageously, sizing the bypass line 312 and the bypass valve 324 as aforementioned permits the use of one single valve to enable a bypass of the ASM cooling heat exchanger 231. In another embodiment, the bypass valve 324 may be a multi-port valve that regulates flow through the ASM cooling heat exchanger 231 and/or through the bypass line 312. In another embodiment, in addition to the bypass valve a second valve may be used by locating a separate valve situated in a common/shared duct with ASM cooling heat exchanger 231. An optional upstream temperature sensor 302, as shown, is arranged downstream of the first thermal conditioning system 320 and upstream of the ASM 225, so that an ASM inlet temperature may be monitored. The controller 235 may also be operably connected to a pressure regulator 328 and one or more outlet sensors 245 (e.g., temperature sensor, oxygen sensor, etc.) which are arranged downstream of the ASM 225. The controller 235 thus may monitor and/or control inlet and outlet temperatures and/or pressures of the air as it passes through the ASM 225 to generate the inerting gas 241. Optionally, the position of bypass valve 324 is actuated on the basis of sensors 245 in order to obtain flow of the pressurize air 208 at a desired temperature.

The first thermal conditioning system 320 is arranged to raise a temperature of the pressurized air 208 prior to entry into the ASM 225. The increased temperature can enable improved efficiency of the ASM 225 for generation of the inerting gas 241.

After the pressurized air 208 passes through the ASM 225, the temperature will remain high. Accordingly, prior to the supplying the inerting gas 241 to the fuel tank 215 and/or the fire-protected space 340, the temperature may be lowered. To achieve this, a second thermal conditioning system 332 is provided. The second thermal conditioning system 332 includes a product gas cooler 334. The product gas cooler 334 may be a heat exchanger located within the ram air duct 243. As shown, in this embodiment, the location of the product gas cooler 334 is upstream of the ASM cooling heat exchanger 231 within the ram air duct 243. Further, as shown, the product gas cooler 334 is illustratively shown as separate from the ASM cooling heat exchanger 231. However, in some embodiments, the product gas cooler 334 and the ASM cooling heat exchanger 231 may be components of a multi-pass heat exchanger, and thus the ASM cooling heat exchanger 231 and the product gas cooler 334 may be located at substantially the same location within the ram air duct 243. In some such embodiments, in a multi-pass heat exchanger, the pass of the product gas cooler 334 is arranged upstream of the ASM cooling heat exchanger 231 relative to a flow of ram air within the ram air duct 243.

The second thermal conditioning system 332 is arranged to reduce a temperature of the inerting gas 241 prior to being supplied into the fuel tank 215 and/or the fire-protected space 340. In one non-limiting embodiment, the first thermal conditioning system 320 is configured (or controlled) to generate upstream air temperatures of 250° F. or greater and the second thermal conditioning system 332 is configured (or controlled) to cool the inerting gas 241 to 200° F. or less. Further, in some embodiments, the upstream temperatures may be between 250° F. and 350° F., and the downstream temperatures may be between 100° F. and 200° F. It will be noted that the desired, cooled outlet air, downstream of the ASM 225 and prior to the fuel tank 215 should be below the auto-ignition temperature of the fuel within the fuel tank 215. The inlet temperature may be selected based on the specific configuration of the ASM 225 (e.g., based on materials of the ASM 225). If a fire is detected in the fire-protected space 340, then the controller 235 may command the inlet temperature to exceed maximum normal operational temperatures (e.g. 180° F.) of the ASM 225 to increase output of the inerting gas 241 for cargo fire suppression, thus requiring the ASM 225 to be replaced after each fire detection. The maximum normal operational temperature of the ASM 225 is about 180° F.

A fire detection sensor 370 may be located in or proximate to the fire-protected space 340. The fire detection sensor 370 may be configured to detect, fire, heat, and/or smoke. The controller 235 is operably connected to the fire detection sensor 370 and the valve 370. When a fire is detected by the fire detection sensor 370, the controller 235 will then command the valve 350 to convey inerting gas 241 into fire-protected space 370. The controller 235 is also operably connected to a first stage fire suppression system 380 and may coordinate operation of the valve 350 with the first stage fire suppression system 380. When a fire is detected by the fire detection sensor 370, the first stage fire suppression system 380 may release a selected amount (e.g., a large amount) of a fire suppression agent into the fire-protected space 240 for a first period of time (e.g., a short period of time) prior to the inerting gas 241 entering into the fire-protected space 340. Once the first period of time has been completed then the controller 235 may activate the valve 350 to release inerting gas 241 into the fire-protected space 240 for the second stage. In an embodiment, a fire suppression agent utilized in the first stage may be bromotrifluoromethane, argon, nitrogen, carbon dioxide, water, atomized water, hydrofluorocarbons, or any other fire suppression agent known to one of skill in the art.

Turning now to FIG. 4, a schematic illustration of a fire suppression system 400 is illustrated in accordance with an embodiment of the present disclosure. The fire suppression system 400 may be similar to that shown and described above, but provides for improved performance of the inerting gas through fuel tank inerting and cargo fire suppression by increased temperatures at the ASM 225. It is understood that while one ASM 225 is illustrated, the embodiments described herein may be applicable to fire suppression systems 400 comprising one or more ASMs 225. The fire suppression system 400 includes a valve 350 to supply inerting gas 241 to the fuel tank 215 and/or a fire-protected space 340. The fire-protected space 340 may include but is not limited to a cargo area, an equipment bay, an electronics compartment, or other any other space that may be outfitted with a fire protection system known to one of skill in the art. The valve 350 may be a multi-port valve, a combination of one or more valves, a three-way valve, or any other valve or valve system known to one of skill in the art. In one embodiment, the valve 350 is configured to simultaneously supply inerting gas 241 to both the fuel tank 215 and the fire-protected space 340 via a valve 350. In another embodiment, the valve 350 is configured to supply inerting gas 241 to the fuel tank 215 or the fire-protected space 340 at a single time. The location of the valve 350 along a flow path of inerting gas 241 may vary as shown previously in FIG. 3A in comparison to FIG. 3B.

In an embodiment, flow of the inerting gas 241 to the fuel tank 215 must pass the pressurized air 208 through the ASM cooling heat exchanger 231 in order to avoid exceeding temperature limits of components of the fuel tank 215. The valve 350 and bypass valve 324 can be interlocked in order to avoid a situation that would introduce hot inerting gas above a desired temperature into a fuel tank 215.

In the case of cargo fire suppression, the pressurized air 208 bypasses ASM cooling heat exchanger 231 so that the inerting gas 241 requires cooling in order to avoid exposing temperature-sensitive cargo such as pets or livestock to hot inerting gas above a desired temperature.

The fire suppression system 400 includes an ASM 225 arranged along a flow path and configured to generate inerting gas 241 and supply such inerting gas to the fuel tank 215 and/or a fire-protected space 340 via the valve 350. The ASM 225 may be a membrane-based ASM, similar to that described above.

Pressurized air 208 (e.g., bleed air) is passed through upstream components, such as a precooler, and subsequently passed through an ASM cooling heat exchanger 231 that is configured to further cool the pressurized air 208 prior to supplying the air to the ASM 225. The ASM cooling heat exchanger 231 may be arranged within a ram air duct 243, similar to the arrangement described above. Further, the fire suppression system 400, as shown, includes an ozone conversion device 221 and a filter 227, arranged upstream of the ASM 225. The fire suppression system 400 further includes a controller 235 that is operably coupled to one or more of the components of the fire suppression system 400.

The fire suppression system 400 further includes a first thermal conditioning system 420 to control an inlet air temperature upstream of the ASM 225 (e.g., increase an upstream air temperature relative to the ASM 225). In this embodiment, the first thermal conditioning system 420 includes a heater 436. The heater 436 may be operably connected to and/or controlled by the controller 235. The heater 436 may be at least one of an electric heater, a combustion heater, a powered heater or may be a passive heater (e.g., heat exchanger). In one non-limiting example of a passive heater, air extracted upstream of the ASM cooling heat exchanger 231 may be employed to reheat the cooled air after passing through the ASM cooling heat exchanger 231. In another non-limiting example of a passive heater, the heat source may be heated hydraulic fluid, heated oil, or heated coolant. In some such embodiments, a control valve may be operated or controlled by the controller 235 (e.g., similar to the bypass valve 324 described above). In another embodiment, the heater 436 may burn fuel or supply heat by a chemical reaction or heating mechanisms, as will be appreciated by those of skill in the art. An optional upstream temperature sensor 302, as shown, is arranged downstream of the heater 436 and upstream of the ASM 402, so that an ASM inlet temperature may be monitored. The controller 235 may also be operably connected to a pressure regulator 328 and one or more outlet sensors 245 (e.g., temperature sensor, oxygen sensor, etc.) which are arranged downstream of the ASM 225. The controller 235 thus may monitor and/or control inlet and outlet temperatures and/or pressures of the air as it passes through the ASM 225 to generate the inerting gas 241.

The first thermal conditioning system 420 is arranged to raise a temperature of the pressurized air 208 prior to entry into the ASM 225. The increased temperature can enable improved efficiency of the ASM 225 for generation of the inerting gas 241.

After the pressurized air 208 passes through the ASM 225, the temperature will remain high. Accordingly, prior to the supplying the inerting gas 241 to the fuel tank 215 and/or the fire-protected space 340, the temperature may be lowered. To achieve this, a second thermal conditioning system 332 is provided. The second thermal conditioning system 332 includes a product gas cooler 334. The product gas cooler 334 may be a heat exchanger located within the ram air duct 243. As shown, in this embodiment, the location of the product gas cooler 334 is upstream of the ASM cooling heat exchanger 231 within the ram air duct 243. Further, as shown, the product gas cooler 334 is illustratively shown as separate from the ASM cooling heat exchanger 231. However, in some embodiments, the product gas cooler 334 and the ASM cooling heat exchanger 231 may be components of a multi-pass heat exchanger, and thus the ASM cooling heat exchanger 231 and the product gas cooler 334 may be located at substantially the same location within the ram air duct 243. In some such embodiments, in a multi-pass heat exchanger, the pass of the product gas cooler 334 is arranged upstream of the ASM cooling heat exchanger 231 relative to a flow of ram air within the ram air duct 243.

The second thermal conditioning system 332 is arranged to reduce a temperature of the inerting gas 241 prior to being supplied into the fuel tank 215 and/or the fire-protected space 340. In one non-limiting embodiment, the first thermal conditioning system 420 is configured (or controlled) to generate upstream air temperatures of 250° F. or greater and the second thermal conditioning system 332 is configured (or controlled) to cool the inerting gas 241 to 200° F. or less. Further, in some embodiments, the upstream temperatures may be between 250° F. and 350° F., and the downstream temperatures may be between 100° F. and 200° F. It will be noted that the desired, cooled outlet air, downstream of the ASM 225 and prior to the fuel tank 215 should be below the auto-ignition temperature of the fuel within the fuel tank 215. The inlet temperature may be selected based on the specific configuration of the ASM 225 (e.g., based on materials of the ASM 225). If a fire is detected in the fire-protected space 340, then the controller 235 may command the inlet temperature to exceed maximum operational temperatures of the ASM 225 to increase output of the inerting gas 241 for cargo fire suppression, thus requiring the ASM 225 to be replaced after each fire detection.

A fire detection sensor 370 may be located in or proximate to the fire-protected space 340. The fire detection sensor 370 may be configured to detect, fire, heat, and/or smoke. The controller 235 is operably connected to the fire detection sensor 370 and the valve 370. When a fire is detected by the fire detection sensor 370, the controller 235 will then command the valve 350 to convey inerting gas 241 into fire-protected space 340. The controller 235 is also operably connected to a first stage fire suppression system 380 and may coordinate operation of the valve 350 with the first stage fire suppression system 380. When a fire is detected by the fire detection sensor 370, the first stage fire suppression system 380 may release a selected amount (e.g., a large amount) of a fire suppression agent into the fire-protected space 340 for a first period of time (e.g., a short period of time) prior to the inerting gas 241 entering into the fire-protected space 340. Once the first period of time has been completed then the controller 235 may activate the valve 350 to release inerting gas 241 into the fire-protected space 340 for the second stage. In an embodiment, a fire suppression agent utilized in the first stage may be bromotrifluoromethane, argon, nitrogen, carbon dioxide, water, atomized water, hydrofluorocarbons, or any other fire suppression agent known to one of skill in the art.

Turning now to FIG. 5, a schematic illustration of a fire suppression system 500 is illustrated in accordance with an embodiment of the present disclosure. The fire suppression system 500 may be similar to that shown and described above, but provides for improved performance of the inerting gas through fuel tank inerting and cargo fire suppression by increased temperatures at the ASM 225. It is understood that while one ASM 225 is illustrated, the embodiments described herein may be applicable to fire suppression systems 500 comprising one or more ASMs 225. The fire suppression system 500 includes a valve 350 to supply inerting gas 241 to the fuel tank 215 and/or a fire-protected space 340. The fire-protected space 340 may include but is not limited to a cargo area, an equipment bay, an electronics compartment, or other any other space that may be outfitted with a fire protection system known to one of skill in the art. The valve 350 may be a multi-port valve, a combination of one or more valves, a three-way valve, or any other valve or valve system known to one of skill in the art. In one embodiment, the valve 350 is configured to simultaneously supply inerting gas 241 to both the fuel tank 215 and the fire-protected space 340 via a valve 350. In another embodiment, the valve 350 is configured to supply inerting gas 241 to the fuel tank 215 or the fire-protected space 340 at a single time. The location of the valve 350 along a flow path of inerting gas 241 may vary as shown previously in FIG. 3A in comparison to FIG. 3B.

The fire suppression system 500 includes an ASM 225 arranged along a flow path and configured to generate inerting gas 241 and supply such inerting gas to the fuel tank 215 and/or a fire-protected space 340 via the valve 350. The ASM 225 may be a membrane-based ASM, similar to that described above.

Pressurized air 208 (e.g., bleed air) is passed through upstream components, such as a precooler, and subsequently passed through an ASM cooling heat exchanger 231 that is configured to further cool the pressurized air 208 prior to supplying the air to the ASM 225. The ASM cooling heat exchanger 231 may be arranged within a ram air duct 243, similar to the arrangement described above. Further, the fire suppression system 500, as shown, includes an ozone conversion device 221 and a filter 227, arranged upstream of the ASM 225. The fire suppression system 500 further includes a controller 235 that is operably coupled to one or more of the components of the fire suppression system 500.

The fire suppression system 500 further includes a first thermal conditioning system 520 to control an inlet air temperature upstream of the ASM 225 (e.g., increase an upstream air temperature relative to the ASM 225). In this embodiment, the first thermal conditioning system 520 includes a boost compressor 538. The boost compressor 538 may be operably connected to and/or controlled by the controller 235. The boost compressor 538 may be an electric or powered compressor, as will be appreciated by those of skill in the art. In some embodiments, the boost compressor 538 may be an oil-free boost compressor. The boost compressor 538 may increase a pressure of the pressurized air 208 after it passes through the ASM cooling heat exchanger 231, thereby increasing a temperature thereof. The boost compressor 538 may be employed, in some embodiments, during a descent of an aircraft and/or during engine idle conditions. A boost bypass valve 540 may be arranged to enable bypassing the boost compressor 538, e.g., the pressure and/or temperature of the pressurized air 208 is already sufficient for the ASM 225 efficiency. An optional upstream temperature sensor 302, as shown, is arranged downstream of the boost compressor 538 and upstream of the ASM 225, so that an ASM inlet temperature may be monitored. The boost bypass valve 540 may be controllable to enable bypassing of the boost compressor 538. The controller 235 may also be operably connected to a boost bypass valve 540. The controller 235 may also be operably connected to a pressure regulator 328 and one or more outlet sensors 245 (e.g., temperature sensor, oxygen sensor, etc.) which are arranged downstream of the ASM 225. The controller 235 thus may monitor and/or control inlet and outlet temperatures and/or pressures of the air as it passes through the ASM 225 to generate the inerting gas 241.

The first thermal conditioning system 520 is arranged to raise a temperature of the pressurized air 208 prior to entry into the ASM 225. The increased temperature can enable improved efficiency of the ASM 225 for generation of the inerting gas 241.

After the pressurized air 208 passes through the ASM 225, the temperature will remain high. Accordingly, prior to the supplying the inerting gas 241 to the fuel tank 215 and/or the fire-protected space 340, the temperature may be lowered. To achieve this, a second thermal conditioning system 332 is provided. The second thermal conditioning system 332 includes a product gas cooler 334. The product gas cooler 334 may be a heat exchanger located within the ram air duct 243. As shown, in this embodiment, the location of the product gas cooler 334 is upstream of the ASM cooling heat exchanger 231 within the ram air duct 243. Further, as shown, the product gas cooler 334 is illustratively shown as separate from the ASM cooling heat exchanger 231. However, in some embodiments, the product gas cooler 334 and the ASM cooling heat exchanger 231 may be components of a multi-pass heat exchanger, and thus the ASM cooling heat exchanger 231 and the product gas cooler 334 may be located at substantially the same location within the ram air duct 243. In some such embodiments, in a multi-pass heat exchanger, the pass of the product gas cooler 334 is arranged upstream of the ASM cooling heat exchanger 231 relative to a flow of ram air within the ram air duct 243.

The second thermal conditioning system 332 is arranged to reduce a temperature of the inerting gas 241 prior to being supplied into the fuel tank 215 and/or the fire-protected space 340. In one non-limiting embodiment, the first thermal conditioning system 420 is configured (or controlled) to generate upstream air temperatures of 250° F. or greater and the second thermal conditioning system 332 is configured (or controlled) to cool the inerting gas 241 to 200° F. or less. Further, in some embodiments, the upstream temperatures may be between 250° F. and 350° F., and the downstream temperatures may be between 100° F. and 200° F. It will be noted that the desired, cooled outlet air, downstream of the ASM 225 and prior to the fuel tank 215 should be below the auto-ignition temperature of the fuel within the fuel tank 215. The inlet temperature may be selected based on the specific configuration of the ASM 225 (e.g., based on materials of the ASM 225). If a fire is detected in the fire-protected space 340, then the controller 235 may command the inlet temperature to exceed maximum operational temperatures of the ASM 225 to increase output of the inerting gas 241 for cargo fire suppression, thus requiring the ASM 225 to be replaced after each fire detection.

A fire detection sensor 370 may be located in or proximate to the fire-protected space 340. The fire detection sensor 370 may be configured to detect, fire, heat, and/or smoke. The controller 235 is operably connected to the fire detection sensor 370 and the valve 370. When a fire is detected by the fire detection sensor 370, the controller 235 will then command the valve 350 to convey inerting gas 241 into fire-protected space 340. The controller 235 is also operably connected to a first stage fire suppression system 380 and may coordinate operation of the valve 350 with the first stage fire suppression system 380. When a fire is detected by the fire detection sensor 370, the first stage fire suppression system 380 may release a selected amount (e.g., a large amount) of a fire suppression agent into the fire-protected space 340 for a first period of time (e.g., a short period of time) prior to the inerting gas 241 entering into the fire-protected space 340. Once the first period of time has been completed then the controller 235 may activate the valve 350 to release inerting gas 241 into the fire-protected space 340 for the second stage. In an embodiment, a fire suppression agent utilized in the first stage may be bromotrifluoromethane, argon, nitrogen, carbon dioxide, water, atomized water, hydrofluorocarbons, or any other fire suppression agent known to one of skill in the art.

Turning now to FIGS. 6A and 6B, a schematic illustration of a fire suppression system 600A, 600B is illustrated in accordance with an embodiment of the present disclosure. The fire suppression system 600A, 600B may be similar to that shown and described above, but provides for improved performance of the inerting gas 241 through fuel tank inerting and cargo fire suppression by increased temperatures at the ASM 225. It is understood that while one ASM 225 is illustrated, the embodiments described herein may be applicable to fire suppression systems 600A, 600B comprising one or more ASMs 225. The fire suppression system 600 includes a valve 350 to supply inerting gas 241 to the fuel tank 215 and/or a fire-protected space 340. The fire-protected space 340 may include but is not limited to a cargo area, an equipment bay, an electronics compartment, or other any other space that may be outfitted with a fire protection system known to one of skill in the art. The valve 350 may be a multi-port valve, a combination of one or more valves, a three-way valve, or any other valve or valve system known to one of skill in the art. In one embodiment, the valve 350 is configured to simultaneously supply inerting gas 241 to both the fuel tank 215 and the fire-protected space 340 via a valve 350. In another embodiment, the valve 350 is configured to supply inerting gas 241 to the fuel tank 215 or the fire-protected space 340 at a single time. The location of the valve 350 along a flow path of inerting gas 241 may vary as previously shown in FIG. 3A in comparison to FIG. 3B.

The fire suppression system 600A, 600B includes an ASM 225 arranged along a flow path and configured to generate inerting gas 241 and supply such inerting gas to the fuel tank 215 and/or a fire-protected space 340 via the valve 350. The ASM 225 may be a membrane-based ASM, similar to that described above.

Pressurized air 208 (e.g., bleed air) is passed through upstream components, such as a precooler, and subsequently passed through an ASM cooling heat exchanger 231 that is configured to further cool the pressurized air 208 prior to supplying the air to the ASM 225. The ASM cooling heat exchanger 231 may be arranged within a ram air duct 243, similar to the arrangement described above. Further, the fire suppression system 600A, 600B, as shown, includes an ozone conversion device 221 and a filter 227, arranged upstream of the ASM 225. The fire suppression system 600A, 600B further includes a controller 235 that is operably coupled to one or more of the components of the fire suppression system 600A, 600B.

In the fire suppression system 600A, 600B a mechanism for increasing the temperature at the inlet to the ASM 225, or upstream thereof, is provided. In this non-limiting embodiment, a first thermal conditioning system 320 is provided. In this embodiment, the first thermal conditioning system 320 is configured to enable a portion (or all) of the relatively warm/hot air to bypass the ASM cooling heat exchanger 231, thus preventing cooling of the pressurized air 208 within the ASM cooling heat exchanger 231. Further, if a portion of the pressurized air 208 is caused to bypass the ASM cooling heat exchanger 231, the bypassing portion may be mixed with pressurized air that has been passed through the ASM cooling heat exchanger 231, thus enabling a mixture of air temperatures, to achieve a desired air temperature upstream of the ASM 225.

Accordingly, in this embodiment, the first thermal conditioning system 320 includes a bypass line 322 and a bypass valve 324. The bypass valve 324 is operable to divert at least a portion of the pressurized air 208 around the ASM cooling heat exchanger 231. The bypass valve 324, in some embodiments, may be operably connected to and/or controlled by the controller 235. The bypass valve 324 may be an actuated bypass valve. The bypass line 312 and the bypass valve 324 may be sized such that when bypass valve 324 is actuated to an open position a pressure drop in the pressurized air 208 flowing through the bypass line 312 and the bypass valve 324 is substantially less than a pressure drop in the pressurized air 208 flowing through the ASM cooling heat exchanger 231. Advantageously, sizing the bypass line 312 and the bypass valve 324 as aforementioned permits the use of one single valve to enable a bypass of the ASM cooling heat exchanger 231. In another embodiment, the bypass valve 324 may be a multi-port valve that regulates flow through the ASM cooling heat exchanger 231 and/or through the bypass line 312. In another embodiment, in addition to the bypass valve a second valve may be used by locating a separate valve situated in a common/shared duct with ASM cooling heat exchanger 231. An optional upstream temperature sensor 302, as shown, is arranged downstream of the first thermal conditioning system 320 and upstream of the ASM 225, so that an ASM inlet temperature may be monitored. The controller 235 may also be operably connected to a pressure regulator 328 and one or more outlet sensors 245 (e.g., temperature sensor, oxygen sensor, etc.) which are arranged downstream of the ASM 225. The controller 235 thus may monitor and/or control inlet and outlet temperatures and/or pressures of the air as it passes through the ASM 225 to generate the inerting gas 241. Optionally, the position of bypass valve 324 is actuated on the basis of sensors 245 in order to obtain flow of the pressurize air 208 at a desired temperature.

The first thermal conditioning system 320 is arranged to raise a temperature of the pressurized air 208 prior to entry into the ASM 225. The increased temperature can enable improved efficiency of the ASM 225 for generation of the inerting gas 241.

After the pressurized air 208 passes through the ASM 225, the temperature will remain high. Accordingly, prior to the supplying the inerting gas 241 to the fuel tank 215 and/or the fire-protected space 340, the temperature may be lowered. To achieve this, a second thermal conditioning system 332 is provided. The second thermal conditioning system 332 includes a product gas cooler 334. The product gas cooler 334 may be a heat exchanger located within the ram air duct 243. As shown, in this embodiment, the location of the product gas cooler 334 is upstream of the ASM cooling heat exchanger 231 within the ram air duct 243. Further, as shown, the product gas cooler 334 is illustratively shown as separate from the ASM cooling heat exchanger 231. However, in some embodiments, the product gas cooler 334 and the ASM cooling heat exchanger 231 may be components of a multi-pass heat exchanger, and thus the ASM cooling heat exchanger 231 and the product gas cooler 334 may be located at substantially the same location within the ram air duct 243. In some such embodiments, in a multi-pass heat exchanger, the pass of the product gas cooler 334 is arranged upstream of the ASM cooling heat exchanger 231 relative to a flow of ram air within the ram air duct 243.

The second thermal conditioning system 332 is arranged to reduce a temperature of the inerting gas 241 prior to being supplied into the fuel tank 215 and/or the fire-protected space 340. In one non-limiting embodiment, the first thermal conditioning system 320 is configured (or controlled) to generate upstream air temperatures of 250° F. or greater and the second thermal conditioning system 332 is configured (or controlled) to cool the inerting gas 241 to 200° F. or less. Further, in some embodiments, the upstream temperatures may be between 250° F. and 350° F., and the downstream temperatures may be between 100° F. and 200° F. It will be noted that the desired, cooled outlet air, downstream of the ASM 225 and prior to the fuel tank 215 should be below the auto-ignition temperature of the fuel within the fuel tank 215. The inlet temperature may be selected based on the specific configuration of the ASM 225 (e.g., based on materials of the ASM 225). If a fire is detected in the fire-protected space 340, then the controller 235 may command the inlet temperature to exceed maximum operational temperatures of the ASM 225 to increase output of the inerting gas 241 for cargo fire suppression, thus requiring the ASM 225 to be replaced after each fire detection.

A fire detection sensor 370 may be located in or proximate to the fire-protected space 340. The fire detection sensor 370 may be configured to detect, fire, heat, and/or smoke. The controller 235 is operably connected to the fire detection sensor 370 and the valve 370. When a fire is detected by the fire detection sensor 370, the controller 235 will then command the valve 350 to convey inerting gas 241 into fire-protected space 340. The controller 235 is also operably connected to a first stage fire suppression system 380 and may coordinate operation of the valve 350 with the first stage fire suppression system 380. When a fire is detected by the fire detection sensor 370, the first stage fire suppression system 380 may release a selected amount (e.g., a large amount) of a fire suppression agent into the fire-protected space 340 for a first period of time (e.g., a short period of time) prior to the inerting gas 241 entering into the fire-protected space 340. Once the first period of time has been completed then the controller 235 may activate the valve 350 to release inerting gas 241 into the fire-protected space 340 for the second stage. In an embodiment, a fire suppression agent utilized in the first stage may be bromotrifluoromethane, argon, nitrogen, carbon dioxide, water, atomized water, hydrofluorocarbons, or any other fire suppression agent known to one of skill in the art.

In an embodiment, the fire suppression system 600A, 600B includes a vacuum generation system 620 operably connected to the ASM 225. In an embodiment, the vacuum generation device 620 in operation generates a vacuum 626.

The vacuum generation system 620 is configured to increase the pressure differential across the ASM 225. The pressure differential across the ASM 225 may be required to be increased during certain times within flight of the aircraft when the pressurized air 208 is being siphoned off for other purposes, such as, for example, during descent and engine idle. In one example pressurized air 208 may be siphoned off and conveyed to the wing anti-ice system 640. In one example, pressurized air 208 may be siphoned off and conveyed to the Environmental Control System 650.

In an embodiment, the vacuum generation system 620 includes a vacuum pump 624, as illustrated in FIG. 6A. In an embodiment, the vacuum pump 624 in operation generates a vacuum 626. The vacuum pump 624 may be a mechanical vacuum pump, a diaphragm vacuum pump, a rocking piston vacuum pump, a scroll vacuum pump, a roots vacuum pump, a parallel screw vacuum pump, a claw type vacuum pump, a rotary vane vacuum pump, or any other vacuum pump known to one of skill in the art.

In an embodiment, the vacuum generation system 620 includes an ejector 670, as illustrated in FIG. 6B. In an embodiment, the ejector 670 in operation generates a vacuum 626. The ejector 670 utilizes a motive fluid to passively create a vacuum 626. The motive fluid 160 may be a pressurized fluid, such as, for example pressurized air 208.

Turning now to FIG. 7 with continued reference to previous figures, a method 700 of supplying inerting gas 241 for fire suppression is illustrated, in accordance with an embodiment of the present disclosure. The method 700 may be performed using fire suppression systems 300A, 300B, 400, 500, 600A, 600B as shown and described above. The fire suppression systems 300A, 300B, 400, 500, 600A, 600B may include one or more features of the first thermal conditioning systems 320, 420, 520 described and the vacuum generation system 620 in the various illustrative embodiments above. For example, the first thermal conditioning system 320, 420, 520 used for the method 700 may include one or more of a bypass valve 324, heater 436, and/or boost compressor 538, and/or other types of heaters or thermal control units/mechanisms as will be appreciated by those of skill in the art. For example, the vacuum generation system 620 may include a vacuum pump 624 or an ejector 670. The fire suppression systems 300A, 300B, 400, 500, 600A, 600B may include the first stage fire suppression system 380. That is, the above described illustrative embodiments are merely for example, and are not to be limiting in scope or bounds.

At block 704, pressurized air 208 is extracted from a pressurized air source 219. The pressurized air source 219 may be an engine 111 or portion thereof, such as a bleed port. The bleed air may be relatively hot. It will be appreciated by those of skill in the art that some or most of the bleed air may be supplied to one or more aircraft systems, such as anti-ice systems, environmental control systems, and fuel tank inerting systems (e.g., OBIGGS) 223. The pressurized air 208 may be pre-cooled, as will be appreciated by those of skill in the art.

At block 706, the pressurized air 208 may be heated with a first thermal conditioning system 320, 420, 520. The first thermal conditioning system 320, 420, 520 is arranged upstream of an ASM 225 that is configured to convert the pressurized air 208 into an inerting gas 241. The first thermal conditioning system 320, 420, 520, as noted above, can include one or more of a bypass valve 324, a heater 436, a boost compressor 538, or other heating mechanism, as will be appreciated by those of skill in the art. The first thermal conditioning system 320, 420, 520 may be configured and/or controlled to generate a pressurized air 208 having a specific temperature or temperature range upstream of an air separation module.

At block 708, the pressurized air 208 is passed from the thermal conditioning system 320, 420, 520 into an ASM 225 to generate the inerting gas 241. The ASM 225 may be a membrane-type ASM 225, with the efficiency thereof governed by Equation (1), described above.

At block 710, the inerting gas 241 may then be provided to the fire-protected space 340 of the aircraft 201 for fire suppression. In an embodiment, a three way valve 350 is actuated to supply the inerting gas 241 to fire-protected space 340.

The method 700 may further comprising that a fire is detected in the fire-protected space 340 using a fire detection sensor 370 and a three way valve 350 is actuated to supply the inerting gas 241 to fire-protected space 340 in response to detection of the fire.

The method 700 may further comprise that a selected amount of a fire suppression agent 382 is supplied into the fire-protected space 340 for a first period of time prior to or overlapping with the inerting gas 370 entering into the fire-protected space 340.

Advantageously, embodiments of the present disclosure are directed to inerting gas systems for fire suppression on an aircraft. Advantageously, embodiments of the present disclosure can increase production of inerting gas by increased temperature of pressured air entering into air separation modules, by providing more optimal temperatures for operation. Moreover, advantageously, air separation modules of inerting gas systems of the present disclosure may not need to be oversized to enable increased performance, and thus smaller systems/packages may be implemented with embodiments of the present disclosure. Furthermore, advantageously, embodiments provided here can generate more inerting gas with similar size systems as prior configurations, e.g., through efficiencies and increased life of the system. Moreover, if a system in accordance with the present disclosure is implemented in the same volume as prior systems, the efficiencies may be further increased and additionally the amount of inerting gas generated may be increased. Also advantageously, a system in accordance with the present disclosure further removes the use of halon for cargo fire suppression low rate discharge.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fire suppression system for an aircraft, the fire suppression system comprising:
a pressurized air source;
an air separation module arranged between the pressurized air source and a fire-protected space, the air separation module configured to generate an inerting gas from pressurized air supplied from the pressurized air source and to supply the inerting gas to the fire-protected space;
a first thermal conditioning system arranged upstream of the air separation module, the first thermal conditioning system configured to increase a temperature of the pressurized air prior to entry into the air separation module; and
a valve arranged upstream of the fire-protected space and downstream of the air separation module.

2. The fire suppression system of claim 1, further comprising:
a second thermal conditioning system arranged downstream of the air separation module and upstream of at least one of a fuel tank or the fire-protected space, the second thermal conditioning system configured to reduce a temperature of the inerting gas prior to entry into at least one of the fuel tank or the fire-protected space.

3. The fire suppression system of claim 2, wherein the valve is arranged upstream of the second thermal conditioning system.

4. The fire suppression system of claim 2, wherein the valve is arranged downstream of the second thermal conditioning system.

5. The fire suppression system of claim 1, further comprising an air separation module cooling heat exchanger located upstream of the air separation module, wherein the pressurized air passes through the air separation module cooling heat exchanger upstream of the air separation module.

6. The fire suppression system of claim 5, wherein the first thermal conditioning system comprises a bypass line and a bypass valve, wherein the bypass valve is operable to divert at least a portion of the pressurized air around the air separation module cooling heat exchanger.

7. The fire suppression system of claim 5, wherein the first thermal conditioning system comprises a heater configured to increase a temperature of the pressurized air after passing through the air separation module cooling heat exchanger.

8. The fire suppression system of claim 7, wherein the heater is at least one of an electric heater, a combustion heater, a powered heater, or a heat exchanger.

9. The fire suppression system of claim 5, wherein the first thermal conditioning system comprises a boost compressor configured to increase a pressure of the pressurized air after passing through the air separation module cooling heat exchanger.

10. The fire suppression system of claim 9, further comprising a boost bypass valve controllable to enable bypassing of the boost compressor.

11. The fire suppression system of claim 5, wherein the air separation module cooling heat exchanger is located in a ram air duct.

12. The fire suppression system of claim 11, wherein the second thermal conditioning system comprises a product gas cooler located in a ram air duct.

13. The fire suppression system of claim 12, wherein the product gas cooler is located upstream relative to the air separation module cooling heat exchanger within the ram air duct.

14. The fire suppression system of claim 1, further comprising a controller configured to control operation of at least one of the first thermal conditioning system or the valve.

15. The fire suppression system of claim 1, further comprising:
a vacuum generation system operably connected to the air separation module, the vacuum generation system being configured to increase a pressure differential across the air separation module.

16. The fire suppression system of claim 1, further comprising:
a first stage fire suppression system configured to release a selected amount of a fire suppression agent into the fire-protected space for a first period of time prior to or overlapping with the inerting gas entering into the fire-protected space.

17. A method of supplying inerting gas to a fire-protected space of an aircraft for fire suppression, the method comprising:
extracting pressurized air from a pressurized air source;
increasing a temperature of the pressurized air with a first thermal conditioning system located upstream of an air separation module;
passing the pressurized air from the thermal conditioning system into the air separation module to generate an inerting gas; and
supplying the inerting gas to the fire-protected space of the aircraft for fire suppression.

18. The method of claim 17, further comprising:
actuating a three way valve to supply the inerting gas to fire-protected space.

19. The method of claim 17, further comprising:
detecting a fire in the fire-protected space using a fire detection sensor; and
actuating a three way valve to supply the inerting gas to fire-protected space in response to detection of the fire.

20. The method of claim 17, further comprising:
supplying a selected amount of a fire suppression agent into the fire-protected space for a first period of time prior to or overleaping with the inerting gas entering into the fire-protected space.
